(19) United States
(12) Patent Application Publication
(10) Pub. No.: US 2019/0108781 A1
(43) Pub. Date: Apr. 11, 2019

(54) DISPLAY DEVICE

(71) Applicant: SHARP KABUSHIKI KAISHA, Sakai City (JP)

(72) Inventor: AKIHISA IWAMOTO, Sakai City (JP)

(21) Appl. No.: 16/147,725

(22) Filed: Sep. 29, 2018

(30) Foreign Application Priority Data
Oct. 6, 2017 (JP) 2017-195894

(51) Int. Cl. G09G 3/20

(52) U.S. Cl. CPC G09G 3/2003; G09G 2300/0426

(57) ABSTRACT

A display device includes: a plurality of source lines extending in a first direction; and a plurality of gate lines extending in a second direction that intersects with the first direction. A plurality of switching elements are connected to one of the plurality of source lines. Each of the plurality of switching elements is connected to one of the plurality of gate lines. The plurality of switching elements connected to the source line are aligned in the first direction so as to be alternately located on the right and left sides of the source line. A plurality of picture elements that include the plurality of switching elements connected to the source line correspond to the same color.

### BACKGROUND

### 1. Field

The present disclosure relates to a display device.

### 2. Description of the Related Art

In the related art, there has been known a liquid crystal display device including a liquid crystal display panel that includes n gate lines extending in a first direction, m+1 data lines extending in a second direction vertical to the first direction, and a large number of pixels that include m pixels in the first direction and n pixels in the second direction and are aligned in a matrix (for example, see Japanese Unexamined Patent Application Publication No. 2011-150371).

In Japanese Unexamined Patent Application Publication No. 2011-150371, each pixel includes a switching element and the switching elements are formed in a zigzag manner along the data lines. The first data line and the last data line are connected to each other. Display that seems to be performed by a dot inversion method is performed through driving by a column inversion method.

Japanese Unexamined Patent Application Publication No. 2011-150371 does not clearly describe the relationship between picture elements and colors, and has no description on a method for dealing with an increase in power consumption during monochromatic (RGB) display. Thus, in the liquid crystal display device described in Japanese Unexamined Patent Application Publication No. 2011-150371, there may be a case that power consumption and radiation noise are increased during monochromatic (RGB) display.

### SUMMARY

In view of the problem described above, the present disclosure is aimed at providing a display device capable of reducing power consumption and radiation noise during white, black, gray, or RGB (monochromatic) screen display, by making an output voltage waveform of a source driver change every vertical scanning period.

According to an aspect of the present disclosure, there is provided a display device including: a plurality of source lines extending in a first direction; and a plurality of gate lines extending in a second direction that intersects with the first direction. A plurality of switching elements are connected to one of the plurality of source lines. Each of the plurality of switching elements is connected to one of the plurality of gate lines. The plurality of switching elements connected to the source line are aligned in the first direction so as to be alternately located on one side and another side of the source line. A plurality of picture elements that include the plurality of switching elements connected to the source line correspond to the same color.

### BRIEF DESCRIPTION OF THE DRAWINGS

FIG. 1 is an overall view illustrating an example of a display device according to a first embodiment;

FIG. 2 is a view functionally illustrating a part of FIG. 1;

FIGS. 3A to 3F are diagrams each illustrating an example of an output voltage waveform of a source driver during white screen display in the display device according to the first embodiment;

FIGS. 4A to 4F are diagrams each illustrating an example of the output voltage waveform of the source driver during R screen display in the display device according to the first embodiment;

FIG. 5 is a view functionally illustrating a part of a display device according to a second embodiment;

FIG. 6 is an overall view illustrating an example of a display device according to a third embodiment;

FIG. 7 is a view functionally illustrating a part of a display device according to a first comparative example;

FIGS. 8A to 8F are diagrams each illustrating an output voltage waveform of a source driver during white screen display in the display device according to the first comparative example;

FIGS. 9A to 9F are diagrams each illustrating an output voltage waveform of the source driver during R screen display in the display device according to the first comparative example;

FIG. 10 is a view functionally illustrating a part of a display device according to a second comparative example;

FIGS. 11A to 11F are diagrams each illustrating an output voltage waveform of a source driver during white screen display in the display device according to the second comparative example;

FIGS. 12A to 12F are diagrams each illustrating an output voltage waveform of the source driver during R screen display in the display device according to the second comparative example;

FIG. 13 is a view functionally illustrating a part of a display device according to a third comparative example;

FIGS. 14A to 14F are diagrams each illustrating an output voltage waveform of a source driver during white screen display in the display device according to the third comparative example; and

FIGS. 15A to 15F are diagrams each illustrating an output voltage waveform of the source driver during R screen display in the display device according to the third comparative example.

### DESCRIPTION OF THE EMBODIMENTS

### First Embodiment

Now, a display device according to a first embodiment of the present disclosure is described.

In each drawing referred to below, components may be illustrated in different scales so that each component is easy to see.

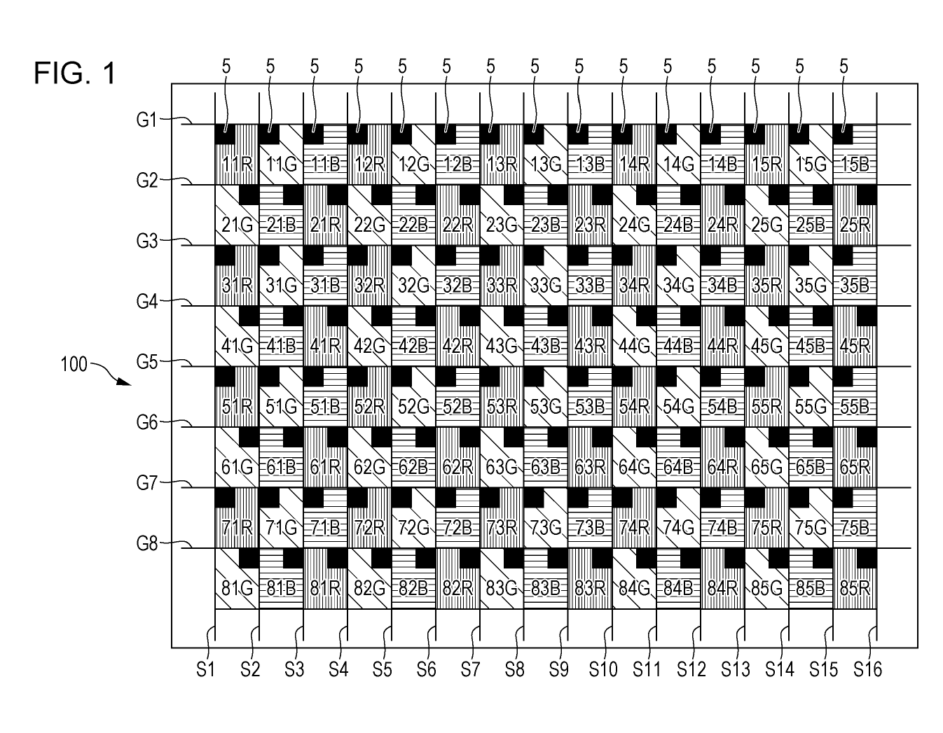

FIG. 1 is an overall view illustrating an example of a display device 100 according to the first embodiment.

In the example illustrated in FIG. 1, the display device 100 includes a plurality of picture elements 11R to 85R, 11G to 85G, and 11B to 85B that are aligned in a matrix with 8 columns and 15 rows. Further, the display device 100 includes 16 source lines (signal wires) S1 to S16 extending in a vertical direction and 8 gate lines (scanning wires) G1 to G8 extending in a lateral direction.

In other examples, the display device 100 may include a plurality of picture elements that are aligned in a matrix with any number of columns and rows other than the matrix with 8 columns and 15 rows.

In the example illustrated in FIG. 1, the plurality of picture elements 11R to 85R, 11G to 85G, and 11B to 85B each include a switching element 5. Gate electrodes of the switching elements 5 of the picture elements 11R to 15R, 11G to 15G, and 11B to 15B are connected to the gate line G1. Gate electrodes of the switching elements 5 of the picture elements 21R to 25R, 21G to 25G, and 21B to 25B are connected to the gate line G2. Gate electrodes of the switching elements 5 of the picture elements 31R to 35R, 31G to 35G, and 31B to 35B are connected to the gate line G3. Gate electrodes of the switching elements 5 of the picture elements 41R to 45R, 41G to 45G, and 41B to 45B are connected to the gate line G4. Gate electrodes of the switching elements 5 of the picture elements 51R to 55R, 51G to 55G, and 51B to 55B are connected to the gate line G5. Gate electrodes of the switching elements 5 of the picture elements 61R to 65R, 61G to 65G, and 61B to 65B are connected to the gate line G6. Gate electrodes of the switching elements 5 of the picture elements 71R to 75R, 71G to 75G, and 71B to 75B are connected to the gate line G7. Gate electrodes of the switching elements 5 of the picture elements 81R to 85R, 81G to 85G, and 81B to 85B are connected to the gate line G8.

To the source line S1, source electrodes of the switching elements 5 of the picture elements 11R, 31R, 51R, and 71R are connected. Further, the picture elements 11R, 31R, 51R, and 71R, which include the switching elements 5 connected to the source line S1, correspond to the same color (red (R)).

To the source line S2, source electrodes of the switching elements 5 of the picture elements 11G, 21G, 31G, 41G, 51G, 61G, 71G, and 81G are connected. Specifically, the switching elements 5 of the picture elements 11G, 21G, 31G, 41G, 51G, 61G, 71G, and 81G connected to the source line S2 are aligned in the vertical direction. Further, the switching elements 5 of the picture elements 11G, 31G, 51G, and 71G are arranged on the right side of the source line S2, and the switching elements 5 of the picture elements 21G, 41G, 61G, and 81G are arranged on the left side of the source line S2. That is, the switching elements 5 of the picture elements 11G, 21G, 31G, 41G, 51G, 61G, 71G, and 81G connected to the source line S2 are aligned in the vertical direction so as to be alternately located on the right and left sides of the source line S2 one by one. Further, the picture elements 11G, 21G, 31G, 41G, 51G, 61G, 71G, and 81G, which include the switching elements 5 connected to the source line S2, correspond to the same color (green (G)).

To the source line S3, source electrodes of the switching elements 5 of the picture elements 11B, 21B, 31B, 41B, 51B, 61B, 71B, and 81B are connected. Specifically, the switching elements 5 of the picture elements 11B, 21B, 31B, 41B, 51B, 61B, 71B, and 81B connected to the source line S3 are aligned in the vertical direction. Further, the switching elements 5 of the picture elements 11B, 31B, 51B, and 71B are arranged on the right side of the source line S3, and the switching elements 5 of the picture elements 21B, 41B, 61B, and 81B are arranged on the left side of the source line S3. That is, the switching elements 5 of the picture elements 11B, 21B, 31B, 41B, 51B, 61B, 71B, and 81B connected to the source line S3 are aligned in the vertical direction so as to be alternately located on the right and left sides of the source line S3 one by one. Further, the picture elements 11B, 21B, 31B, 41B, 51B, 61B, 71B, and 81B, which include the switching elements 5 connected to the source line S3, correspond to the same color (blue (B)).

To the source line S4, source electrodes of the switching elements 5 of the picture elements 12R, 21R, 32R, 41R, 52R, 61R, 72R, and 81R are connected. Specifically, the switching elements 5 of the picture elements 12R, 21R, 32R, 41R, 52R, 61R, 72R, and 81R connected to the source line S4 are aligned in the vertical direction. Further, the switching elements 5 of the picture elements 12R, 32R, 52R, and 72R are arranged on the right side of the source line S4, and the switching elements 5 of the picture elements 21R, 41R, 61R, and 81R are arranged on the left side of the source line S4. That is, the switching elements 5 of the picture elements 12R, 21R, 32R, 41R, 52R, 61R, 72R, and 81R connected to the source line S4 are aligned in the vertical direction so as to be alternately located on the right and left sides of the source line S4 one by one. Further, the picture elements 12R, 21R, 32R, 41R, 52R, 61R, 72R, and 81R, which include the switching elements 5 connected to the source line S4, correspond to the same color (red (R)).

To the source line S5, source electrodes of the switching elements 5 of the picture elements 12G, 22G, 32G, 42G, 52G, 62G, 72G, and 82G are connected. The source electrodes of the switching elements 5 of the picture elements 12G, 22G, 32G, 42G, 52G, 62G, 72G, and 82G are connected to the source line S5 in a manner similar to the way the source electrodes of the switching elements 5 of the picture elements 11G, 21G, 31G, 41G, 51G, 61G, 71G, and 81G are connected to the source line S2. Further, the picture elements 12G, 22G, 32G, 42G, 52G, 62G, 72G, and 82G, which include the switching elements 5 connected to the source line S5, correspond to the same color (green (G)).

To the source line S6, source electrodes of the switching elements 5 of the picture elements 12B, 22B, 32B, 42B, 52B, 62B, 72B, and 82B are connected. The source electrodes of the switching elements 5 of the picture elements 12B, 22B, 32B, 42B, 52B, 62B, 72B, and 82B are connected to the source line S6 in a manner similar to the way the source electrodes of the switching elements 5 of the picture elements 11B, 21B, 31B, 41B, 51B, 61B, 71B, and 81B are connected to the source line S3. Further, the picture elements 12B, 22B, 32B, 42B, 52B, 62B, 72B, and 82B, which include the switching elements 5 connected to the source line S6, correspond to the same color (blue (B)).

To the source line S7, source electrodes of the switching elements 5 of the picture elements 13R, 22R, 33R, 42R, 53R, 62R, 73R, and 82R are connected. The source electrodes of the switching elements 5 of the picture elements 13R, 22R, 33R, 42R, 53R, 62R, 73R, and 82R are connected to the source line S7 in a manner similar to the way the source electrodes of the switching elements 5 of the picture elements 12R, 21R, 32R, 41R, 52R, 61R, 72R, and 81R are connected to the source line S4. Further, the picture elements 13R, 22R, 33R, 42R, 53R, 62R, 73R, and 82R, which include the switching elements 5 connected to the source line S7, correspond to the same color (red (R)).

To the source line S8, source electrodes of the switching elements 5 of the picture elements 13G, 23G, 33G, 43G, 53G, 63G, 73G, and 83G are connected. The source electrodes of the switching elements 5 of the picture elements 13G, 23G, 33G, 43G, 53G, 63G, 73G, and 83G are connected to the source line S8 in a manner similar to the way the source electrodes of the switching elements 5 of the picture elements 11G, 21G, 31G, 41G, 51G, 61G, 71G, and 81G are connected to the source line S2. Further, the picture elements 13G, 23G, 33G, 43G, 53G, 63G, 73G, and 83G, which include the switching elements 5 connected to the source line S8, correspond to the same color (green (G)).

To the source line S9, source electrodes of the switching elements 5 of the picture elements 13B, 23B, 33B, 43B, 53B, 63B, 73B, and 83B are connected. The source electrodes of the switching elements 5 of the picture elements 13B, 23B, 33B, 43B, 53B, 63B, 73B, and 83B are connected to the source line S9 in a manner similar to the way the source electrodes of the switching elements 5 of the picture elements 11B, 21B, 31B, 41B, 51B, 61B, 71B, and 81B are connected to the source line S3. Further, the picture elements 13B, 23B, 33B, 43B, 53B, 63B, 73B, and 83B, which include the switching elements 5 connected to the source line S9, correspond to the same color (blue (B)).

To the source line S10, source electrodes of the switching elements 5 of the picture elements 14R, 23R, 34R, 43R, 54R, 63R, 74R, and 83R are connected. The source electrodes of the switching elements 5 of the picture elements 14R, 23R, 34R, 43R, 54R, 63R, 74R, and 83R are connected to the source line S10 in a manner similar to the way the source electrodes of the switching elements 5 of the picture elements 12R, 21R, 32R, 41R, 52R, 61R, 72R, and 81R are connected to the source line S4. Further, the picture elements 14R, 23R, 34R, 43R, 54R, 63R, 74R, and 83R, which include the switching elements 5 connected to the source line S10, correspond to the same color (red (R)).

To the source line S11, source electrodes of the switching elements 5 of the picture elements 14G, 24G, 34G, 44G, 54G, 64G, 74G, and 84G are connected. The source electrodes of the switching elements 5 of the picture elements 14G, 24G, 34G, 44G, 54G, 64G, 74G, and 84G are connected to the source line S11 in a manner similar to the way the source electrodes of the switching elements 5 of the picture elements 11G, 21G, 31G, 41G, 51G, 61G, 71G, and 81G are connected to the source line S2. Further, the picture elements 14G, 24G, 34G, 44G, 54G, 64G, 74G, and 84G, which include the switching elements 5 connected to the source line S11, correspond to the same color (green (G)).

To the source line S12, source electrodes of the switching elements 5 of the picture elements 14B, 24B, 34B, 44B, 54B, 64B, 74B, and 84B are connected. The source electrodes of the switching elements 5 of the picture elements 14B, 24B, 34B, 44B, 54B, 64B, 74B, and 84B are connected to the source line S12 in a manner similar to the way the source electrodes of the switching elements 5 of the picture elements 11B, 21B, 31B, 41B, 51B, 61B, 71B, and 81B are connected to the source line S3. Further, the picture elements 14B, 24B, 34B, 44B, 54B, 64B, 74B, and 84B, which include the switching elements 5 connected to the source line S12, correspond to the same color (blue (B)).

To the source line S13, source electrodes of the switching elements 5 of the picture elements 15R, 24R, 35R, 44R, 55R, 64R, 75R, and 84R are connected. The source electrodes of the switching elements 5 of the picture elements 15R, 24R, 35R, 44R, 55R, 64R, 75R, and 84R are connected to the source line S13 in a manner similar to the way the source electrodes of the switching elements 5 of the picture elements 12R, 21R, 32R, 41R, 52R, 61R, 72R, and 81R are connected to the source line S4. Further, the picture elements 15R, 24R, 35R, 44R, 55R, 64R, 75R, and 84R, which include the switching elements 5 connected to the source line S13, correspond to the same color (red (R)).

To the source line S14, source electrodes of the switching elements 5 of the picture elements 15G, 25G, 35G, 45G, 55G, 65G, 75G, and 85G are connected. The source electrodes of the switching elements 5 of the picture elements 15G, 25G, 35G, 45G, 55G, 65G, 75G, and 85G are connected to the source line S14 in a manner similar to the way the source electrodes of the switching elements 5 of the picture elements 11G, 21G, 31G, 41G, 51G, 61G, 71G, and 81G are connected to the source line S2. Further, the picture elements 15G, 25G, 35G, 45G, 55G, 65G, 75G, and 85G, which include the switching elements 5 connected to the source line S14, correspond to the same color (green (G)).

To the source line S15, source electrodes of the switching elements 5 of the picture elements 15B, 25B, 35B, 45B, 55B, 65B, 75B, and 85B are connected. The source electrodes of the switching elements 5 of the picture elements 15B, 25B, 35B, 45B, 55B, 65B, 75B, and 85B are connected to the source line S15 in a manner similar to the way the source electrodes of the switching elements 5 of the picture elements 11B, 21B, 31B, 41B, 51B, 61B, 71B, and 81B are connected to the source line S3. Further, the picture elements 15B, 25B, 35B, 45B, 55B, 65B, 75B, and 85B, which include the switching elements 5 connected to the source line S15, correspond to the same color (blue (B)).

To the source line S16, source electrodes of the switching elements 5 of the picture elements 25R, 45R, 65R, and 85R are connected. Further, the picture elements 25R, 45R, 65R, and 85R, which include the switching elements 5 connected to the source line S16, correspond to the same color (red (R)).

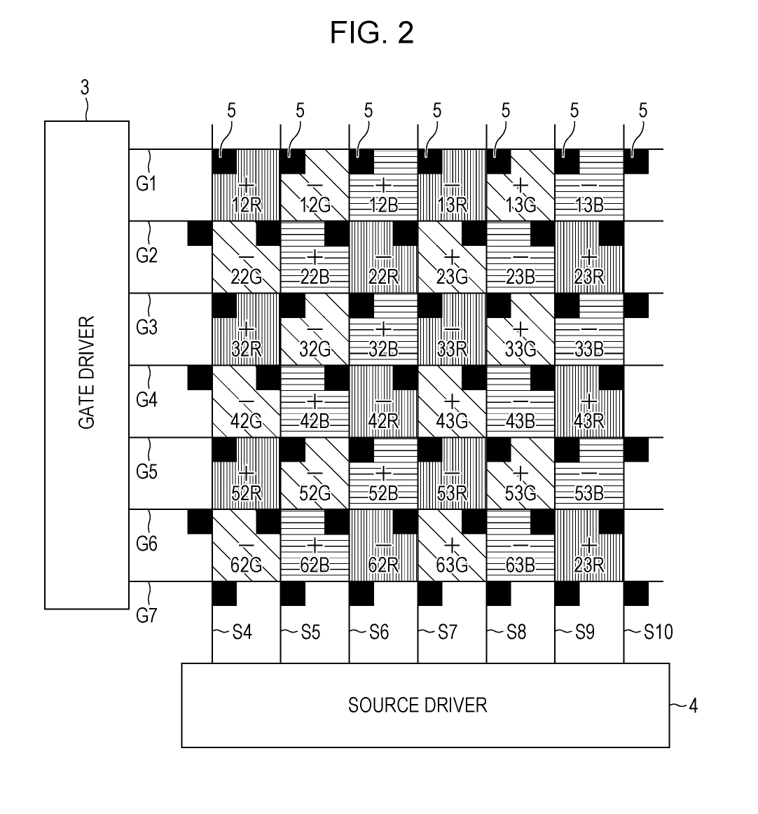

FIG. 2 is a view functionally illustrating a part of FIG. 1.

In the example illustrated in FIG. 2, the picture elements 12R, 32R, and 52R, which include the switching elements 5 connected to the source line S4, have a positive (+) polarity, that is, the same polarity. The picture elements 12G, 22G, 32G, 42G, 52G, and 62G, which include the switching elements 5 connected to the source line S5, have a negative (−) polarity, that is, the same polarity. The picture elements 12B, 22B, 32B, 42B, 52B, and 62B, which include the switching elements 5 connected to the source line S6, have the positive (+) polarity, that is, the same polarity.

The picture elements 13R, 22R, 33R, 42R, 53R, and 62R, which include the switching elements 5 connected to the source line S7, have the negative (−) polarity, that is, the same polarity. The picture elements 13G, 23G, 33G, 43G, 53G, and 63G, which include the switching elements 5 connected to the source line S8, have the positive (+) polarity, that is, the same polarity. The picture elements 13B, 23B, 33B, 43B, 53B, and 63B, which include the switching elements 5 connected to the source line S9, have the negative (−) polarity, that is, the same polarity.

The picture elements 23R, 43R, and 63R, which include the switching elements 5 connected to the source line S10, have the positive (+) polarity, that is, the same polarity.

In the example illustrated in FIG. 2, the polarities of the adjacent picture elements are different from each other in the vertical direction and the lateral direction. Specifically, for example, the (positive) polarity of the picture element 22B and the (negative) polarity of the picture element 12G, which is located on the upper side of the picture element 22B and adjacent thereto, are different from each other. Further, the (positive) polarity of the picture element 22B and the (negative) polarity of the picture element 32G, which is located on the lower side of the picture element 22B and adjacent thereto, are different from each other. Further, the (positive) polarity of the picture element 22B and the (negative) polarity of the picture element 22R, which is located on the right side of the picture element 22B and adjacent thereto, are different from each other. Further, the (positive) polarity of the picture element 22B and the (negative) polarity of the picture element 22G, which is located on the left side of the picture element 22B and adjacent thereto, are different from each other. Thus, flicker can be reduced.

In the example illustrated in FIG. 2, a source driver (signal wire driving circuit) 4 is connected to the source lines S4 to S10. Although not illustrated, the source driver 4 is also connected to the source lines S1 to S3 and S11 to S16 (see FIG. 1).

Further, in the example illustrated in FIG. 2, a gate driver 3 (scanning wire driving circuit) is connected to the gate lines G1 to G7. Although not illustrated, the gate driver 3 is also connected to the gate line G8 (see FIG. 1).

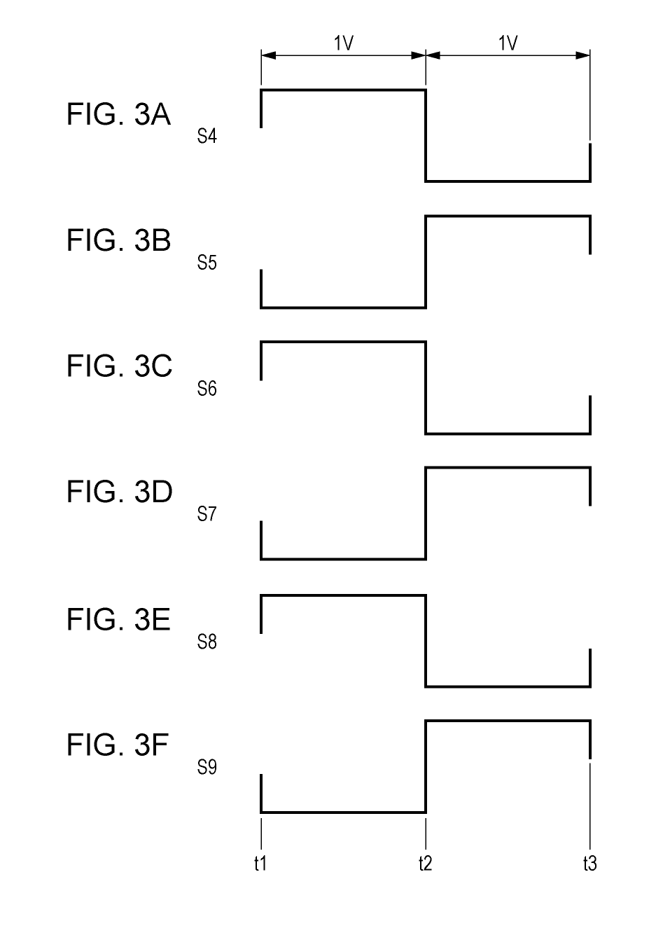

FIGS. 3A to 3F are diagrams each illustrating an example of an output voltage waveform of the source driver 4 during white screen display in the display device 100 according to the first embodiment. Specifically, FIG. 3A illustrates an output voltage waveform of the source driver 4 to the source line S4 during white screen display. FIG. 3B illustrates an output voltage waveform of the source driver 4 to the source line S5 during white screen display. FIG. 3C illustrates an output voltage waveform of the source driver 4 to the source line S6 during white screen display. FIG. 3D illustrates an output voltage waveform of the source driver 4 to the source line S7 during white screen display. FIG. 3E illustrates an output voltage waveform of the source driver 4 to the source line S8 during white screen display. FIG. 3F illustrates an output voltage waveform of the source driver 4 to the source line S9 during white screen display.

In the examples illustrated in FIGS. 3A to 3F, the output voltage waveforms of the source driver 4 to the source lines S4 to S9 during white screen display change at time t1, time t2, and time t3. Specifically, for example, the output voltage waveform of the source driver 4 to the source line S4 changes from negative to positive at the time t1, changes from positive to negative at the time t2, and changes from negative to positive at the time t3. The output voltage waveform of the source driver 4 to the source line S5 changes from positive to negative at the time t1, changes from negative to positive at the time t2, and changes from positive to negative at the time t3. A period (t2−t1) and a period (t3−t2) are each equal to one vertical scanning period (1V). That is, the output voltage waveforms of the source driver 4 to the source lines S4 to S9 during white screen display change every vertical scanning period (1V). One vertical scanning period (1V) is not a period defined by input video signals, but a period defined for the display device 100. One vertical scanning period (1V) is a period from when a signal voltage is supplied to a picture element to when a signal voltage is supplied to the picture element again.

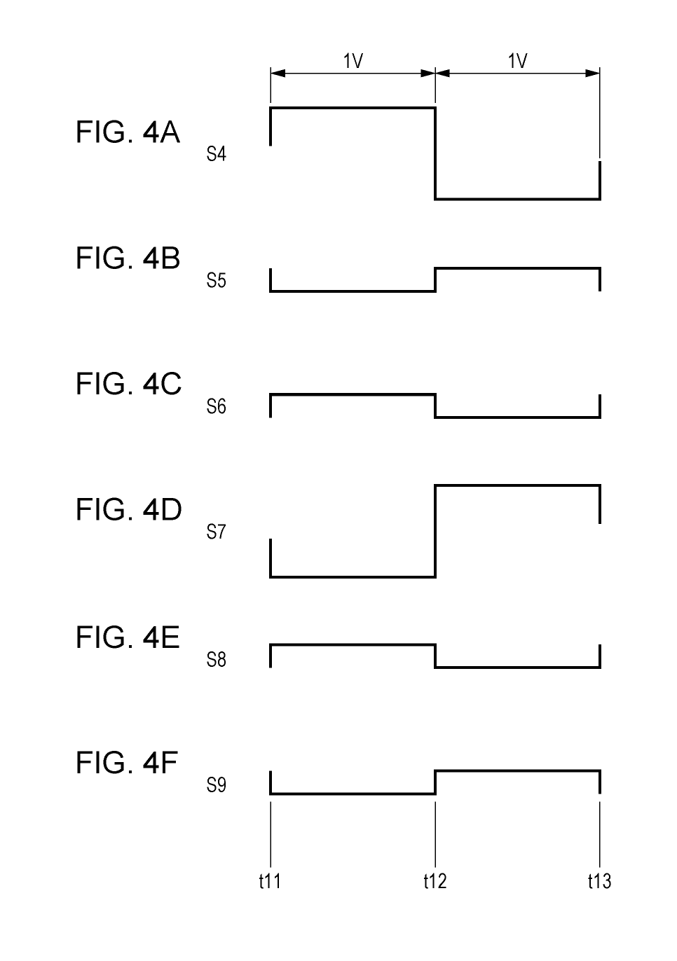

FIGS. 4A to 4F are diagrams each illustrating an example of the output voltage waveform of the source driver 4 during R screen display in the display device 100 according to the first embodiment. Specifically, FIG. 4A illustrates an output voltage waveform of the source driver 4 to the source line S4 during R screen display. FIG. 4B illustrates an output voltage waveform of the source driver 4 to the source line S5 during R screen display. FIG. 4C illustrates an output voltage waveform of the source driver 4 to the source line S6 during R screen display. FIG. 4D illustrates an output voltage waveform of the source driver 4 to the source line S7 during R screen display. FIG. 4E illustrates an output voltage waveform of the source driver 4 to the source line S8 during R screen display. FIG. 4F illustrates an output voltage waveform of the source driver 4 to the source line S9 during R screen display.

In the examples illustrated in FIGS. 4A to 4F, the output voltage waveforms of the source driver 4 to the source lines S4 to S9 during R screen display change at time t11, time t12, and time t13. Specifically, for example, the output voltage waveform of the source driver 4 to the source line S4 changes from negative to positive at the time t11, changes from positive to negative at the time t12, and changes from negative to positive at the time t13. The output voltage waveform of the source driver 4 to the source line S5 changes from positive to negative at the time t11, changes from negative to positive at the time t12, and changes from positive to negative at the time t13. A period (t12−t11) and a period (t13−t12) are each equal to one vertical scanning period (1V). That is, the output voltage waveforms of the source driver 4 to the source lines S4 to S9 during R screen display change every vertical scanning period (1V).

In the display device 100 according to the first embodiment, the output voltage waveform of the source driver 4 changes every vertical scanning period (1V) during white, black, gray, or RGB screen display. Thus, the display device 100 can reduce power consumption and radiation noise compared to a case where the output voltage waveform of the source driver 4 changes every horizontal scanning period (1H).

Further, in the display device 100 according to the first embodiment, as illustrated in FIG. 2, the polarities of the adjacent picture elements are different from each other in the vertical direction and the lateral direction, and hence flicker can be reduced.

### Second Embodiment

Now, a display device according to a second embodiment of the present disclosure is described.

A display device 100 according to the second embodiment has the same configuration as the above-mentioned display device 100 according to the first embodiment except for the following points. Thus, the display device 100 according to the second embodiment can provide the same effects as the above-mentioned display device 100 according to the first embodiment, except for the following points.

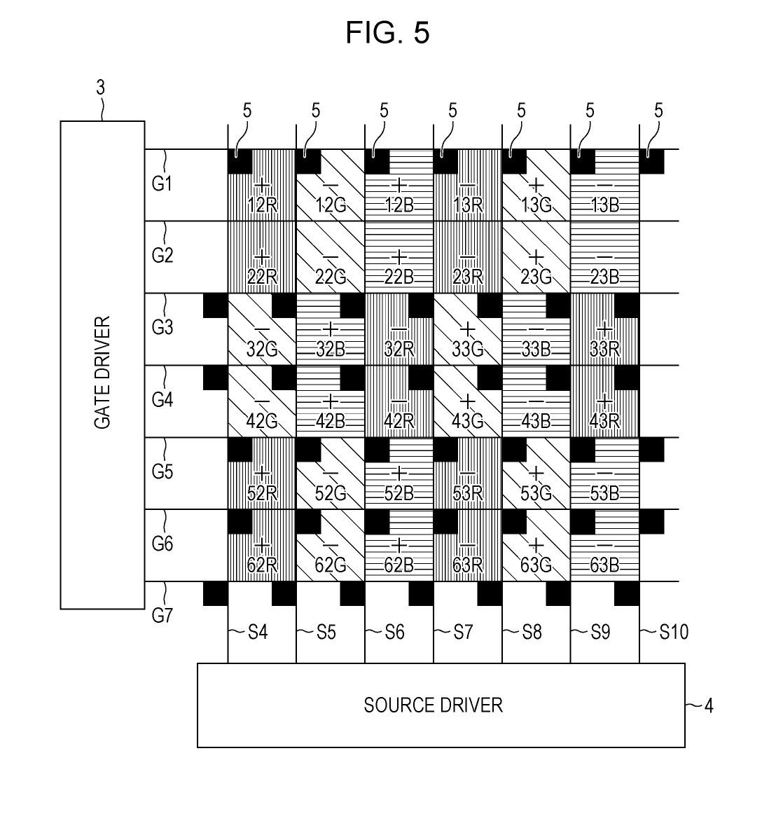

FIG. 5 is a view functionally illustrating a part of the display device 100 according to the second embodiment.

In the display device 100 according to the first embodiment, as illustrated in FIG. 2, the switching elements 5 of the picture elements 12G, 22G, 32G, 42G, 52G, and 62G connected to the source line S5 are aligned in the vertical direction so as to be alternately located on the right and left sides of the source line S5 one by one.

Meanwhile, in the display device 100 according to the second embodiment, as illustrated in FIG. 5, the switching elements 5 of the picture elements 12G, 22G, 32G, 42G, 52G, and 62G connected to the source line S5 are aligned in the vertical direction so that the switching elements 5 are alternately located two at a time on the right and left sides of the source line S5.

Specifically, in the display device 100 according to the second embodiment, like the display device 100 according to the first embodiment, the switching elements 5 of the picture elements 12G, 22G, 32G, 42G, 52G, and 62G connected to the source line S5 are aligned in the vertical direction.

In the display device 100 according to the second embodiment, unlike the display device 100 according to the first embodiment, the switching elements 5 of the picture elements 12G, 22G, 52G, and 62G are arranged on the right side of the source line S5, and the switching elements 5 of the picture elements 32G and 42G are arranged on the left side of the source line S5. That is, the switching elements 5 of the picture elements 12G, 22G, 32G, 42G, 52G, and 62G connected to the source line S5 are aligned in the vertical direction so that the switching elements 5 are alternately located two at a time on the right and left sides of the source line S5.

Further, in the display device 100 according to the second embodiment, like the display device 100 according to the first embodiment, the picture elements 12G, 22G, 32G, 42G, 52G, and 62G, which include the switching elements 5 connected to the source line S5, correspond to the same color (green (G)).

Further, in the display device 100 according to the second embodiment, as illustrated in FIG. 5, the switching elements 5 of the picture elements 12B, 22B, 32B, 42B, 52B, and 62B connected to the source line S6 are aligned in the vertical direction so that the switching elements 5 are alternately located two at a time on the right and left sides of the source line S6.

The switching elements 5 of the picture elements 13R, 23R, 32R, 42R, 53R, and 63R connected to the source line S7 are aligned in the vertical direction so that the switching elements 5 are alternately located two at a time on the right and left sides of the source line S7.

The switching elements 5 of the picture elements 13G, 23G, 33G, 43G, 53G, and 63G connected to the source line S8 are aligned in the vertical direction so that the switching elements 5 are alternately located two at a time on the right and left sides of the source line S8.

The switching elements 5 of the picture elements 13B, 23B, 33B, 43B, 53B, and 63B connected to the source line S9 are aligned in the vertical direction so that the switching elements 5 are alternately located two at a time on the right and left sides of the source line S9.

Further, in the display device 100 according to the second embodiment, as illustrated in FIG. 5, the colors of color filters of the plurality of picture elements aligned on one side of one source line in the vertical direction are different for each two picture elements.

Specifically, on the left side of the source line S5, the picture elements 12R, 22R, 32G, 42G, 52R, and 62R are aligned in the vertical direction. The color of the color filters of the picture elements 12R and 22R is red (R), and the color of the color filters of the picture elements 32G and 42G, which are aligned on the lower side of the picture elements 12R and 22R, is green (G), which is different from red (R). The color of the color filters of the picture elements 52R and 62R, which are aligned on the lower side of the picture elements 32G and 42G, is red (R), which is different from green (G).

On the right side of the source line S5 (the left side of the source line S6), the picture elements 12G, 22G, 32B, 42B, 52G, and 62G are aligned in the vertical direction. The color of the color filters of the picture elements 12G and 22G is green (G), and the color of the color filters of the picture elements 32B and 42B, which are aligned on the lower side of the picture elements 12G and 22G, is blue (B), which is different from green (G). The color of the color filters of the picture elements 52G and 62G, which are aligned on the lower side of the picture elements 32B and 42B, is green (G), which is different from blue (B).

On the right side of the source line S6 (the left side of the source line S7), the picture elements 12B, 22B, 32R, 42R, 52B, and 62B are aligned in the vertical direction. The color of the color filters of the picture elements 12B and 22B is blue (B), and the color of the color filters of the picture elements 32R and 42R, which are aligned on the lower side of the picture elements 12B and 22B, is red (R), which is different from blue (B). The color of the color filters of the picture elements 52B and 62B, which are aligned on the lower side of the picture elements 32R and 42R, is blue (B), which is different from red (R).

On the right side of the source line S7 (the left side of the source line S8), the picture elements 13R, 23R, 33G, 43G, 53R, and 63R are aligned in the vertical direction. The color of the color filters of the picture elements 13R and 23R is red (R), and the color of the color filters of the picture elements 33G and 43G, which are aligned on the lower side of the picture elements 13R and 23R, is green (G), which is different from red (R). The color of the color filters of the picture elements 53R and 63R, which are aligned on the lower side of the picture elements 33G and 43G, is red (R), which is different from green (G).

On the right side of the source line S8 (the left side of the source line S9), the picture elements 13G, 23G, 33B, 43B, 53G, and 63G are aligned in the vertical direction. The color of the color filters of the picture elements 13G and 23G is green (G), and the color of the color filters of the picture elements 33B and 43B, which are aligned on the lower side of the picture elements 13G and 23G, is blue (B), which is different from green (G). The color of the color filters of the picture elements 53G and 63G, which are aligned on the lower side of the picture elements 33B and 43B, is green (G), which is different from blue (B).

On the right side of the source line S9 (the left side of the source line S10), the picture elements 13B, 23B, 33R, 43R, 53B, and 63B are aligned in the vertical direction. The color of the color filters of the picture elements 13B and 23B is blue (B), and the color of the color filters of the picture elements 33R and 43R, which are aligned on the lower side of the picture elements 13B and 23B, is red (R), which is different from blue (B). The color of the color filters of the picture elements 53B and 63B, which are aligned on the lower side of the picture elements 33R and 43R, is blue (B), which is different from red (R).

Further, in the display device 100 according to the second embodiment, as illustrated in FIG. 5, the picture elements 12R, 22R, 52R, and 62R, which include the switching elements 5 connected to the source line S4, have the positive (+) polarity, that is, the same polarity. The picture elements 12G, 22G, 32G, 42G, 52G, and 62G, which include the switching elements 5 connected to the source line S5, have the negative (−) polarity, that is, the same polarity. The picture elements 12B, 22B, 32B, 42B, 52B, and 62B, which include the switching elements 5 connected to the source line S6, have the positive (+) polarity, that is, the same polarity.

The picture elements 13R, 23R, 32R, 42R, 53R, and 63R, which include the switching elements 5 connected to the source line S7, have the negative (−) polarity, that is, the same polarity. The picture elements 13G, 23G, 33G, 43G, 53G, and 63G, which include the switching elements 5 connected to the source line S8, have the positive (+) polarity, that is, the same polarity. The picture elements 13B, 23B, 33B, 43B, 53B, and 63B, which include the switching elements 5 connected to the source line S9, have the negative (−) polarity, that is, the same polarity.

The picture elements 33R and 43R, which include the switching elements 5 connected to the source line S10, have the positive (+) polarity, that is, the same polarity.

### Third Embodiment

Now, a display device according to a third embodiment of the present disclosure is described.

A display device 100 according to the third embodiment has the same configuration as the above-mentioned display device 100 according to the first embodiment except for the following points. Thus, the display device 100 according to the third embodiment can provide the same effects as the above-mentioned display device 100 according to the first embodiment, except for the following points.

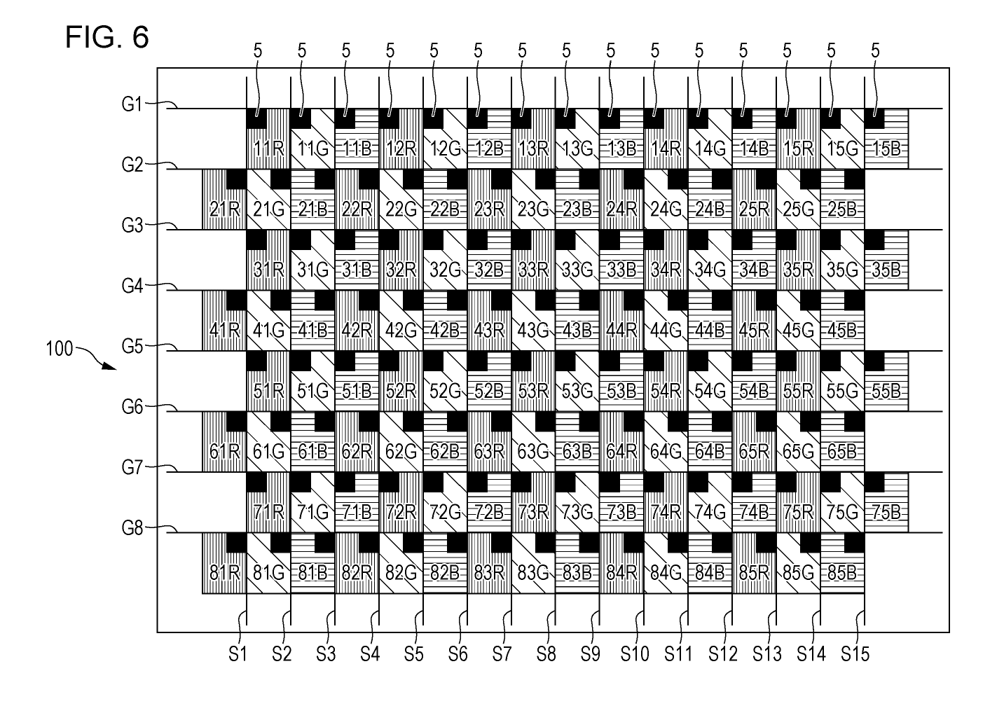

FIG. 6 is an overall view illustrating an example of the display device 100 according to the third embodiment.

In the display device 100 according to the first embodiment, as illustrated in FIG. 1, the left-end picture elements 11R, 21G, 31R, 41G, 51R, 61G, 71R, and 81G are linearly aligned, and the right-end picture elements 15B, 25R, 35B, 45R, 55B, 65R, 75B, and 85R are linearly aligned.

Meanwhile, in the display device 100 according to the third embodiment, as illustrated in FIG. 6, the left-end picture elements 11R, 21R, 31R, 41R, 51R, 61R, 71R, and 81R are aligned in a zigzag manner, and the right-end picture elements 15B, 25B, 35B, 45B, 55B, 65B, 75B, and 85B are aligned in a zigzag manner.

Specifically, in the display device 100 according to the third embodiment, as illustrated in FIG. 6, the left-end picture element 11R of the plurality of picture elements 11R to 15R, 11G to 15G, and 11B to 15B, which include the plurality of switching elements 5 connected to the gate line G1, is arranged on the right side of the left-end picture element 21R of the plurality of picture elements 21R to 25R, 21G to 25G, and 21B to 25B, which include the plurality of switching elements 5 connected to the gate line G2 adjacent to the gate line G1.

The right-end picture element 15B of the plurality of picture elements 11R to 15R, 11G to 15G, and 11B to 15B, which include the plurality of switching elements 5 connected to the gate line G1, is arranged on the right side of the right-end picture element 25B of the plurality of picture elements 21R to 25R, 21G to 25G, and 21B to 25B, which include the plurality of switching elements 5 connected to the gate line G2.

The left-end picture element 21R of the plurality of picture elements 21R to 25R, 21G to 25G, and 21B to 25B, which include the plurality of switching elements 5 connected to the gate line G2, is arranged on the left side of the left-end picture element 31R of the plurality of picture elements 31R to 35R, 31G to 35G, and 31B to 35B, which include the plurality of switching elements 5 connected to the gate line G3 that is arranged on the opposite side of the gate line G1 with respect to the gate line G2 and is adjacent to the gate line G2.

The right-end picture element 25B of the plurality of picture elements 21R to 25R, 21G to 25G, and 21B to 25B, which include the plurality of switching elements 5 connected to the gate line G2, is arranged on the left side of the right-end picture element 35B of the plurality of picture elements 31R to 35R, 31G to 35G, and 31B to 35B, which include the plurality of switching elements 5 connected to the gate line G3.

In the display device 100 according to the first embodiment, as illustrated in FIG. 1, the picture element 11R, the picture element 31R, the picture element 51R, and the picture element 71R, which are located in the same column, are arranged at intervals. Thus, there may be a case that, when a red line is displayed in the longitudinal direction on a low-resolution panel, the red line in the longitudinal direction is seen as a dashed line.

Meanwhile, in the display device 100 according to the third embodiment, as illustrated in FIG. 6, the picture element 21R is arranged between the picture element 11R and the picture element 31R, the picture element 41R is arranged between the picture element 31R and the picture element 51R, and the picture element 61R is arranged between the picture element 51R and the picture element 71R. Thus, the display device 100 according to the third embodiment can reduce the possibility that a red line in the longitudinal direction is seen as a dashed line.

Further, in the display device 100 according to the first embodiment, as illustrated in FIG. 1, the 16 source lines S1 to S16 are driven, that is, the number of source lines is larger by one than the number of picture elements in the horizontal direction, which is 15.

Meanwhile, in the display device 100 according to the third embodiment, as illustrated in FIG. 6, the 15 source lines S1 to S15 may be driven, that is, the number of source lines is the same as the number of picture elements in the horizontal direction, which is 15. Thus, an extra source line driving circuit is not provided to the source driver 4, and the circuit can be simplified as a result.

### First Comparative Example

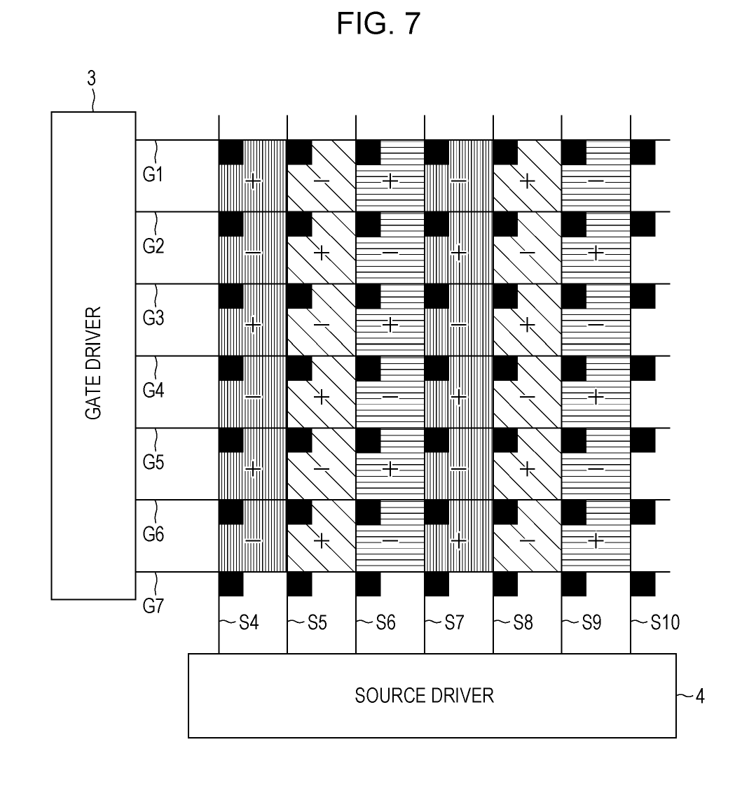

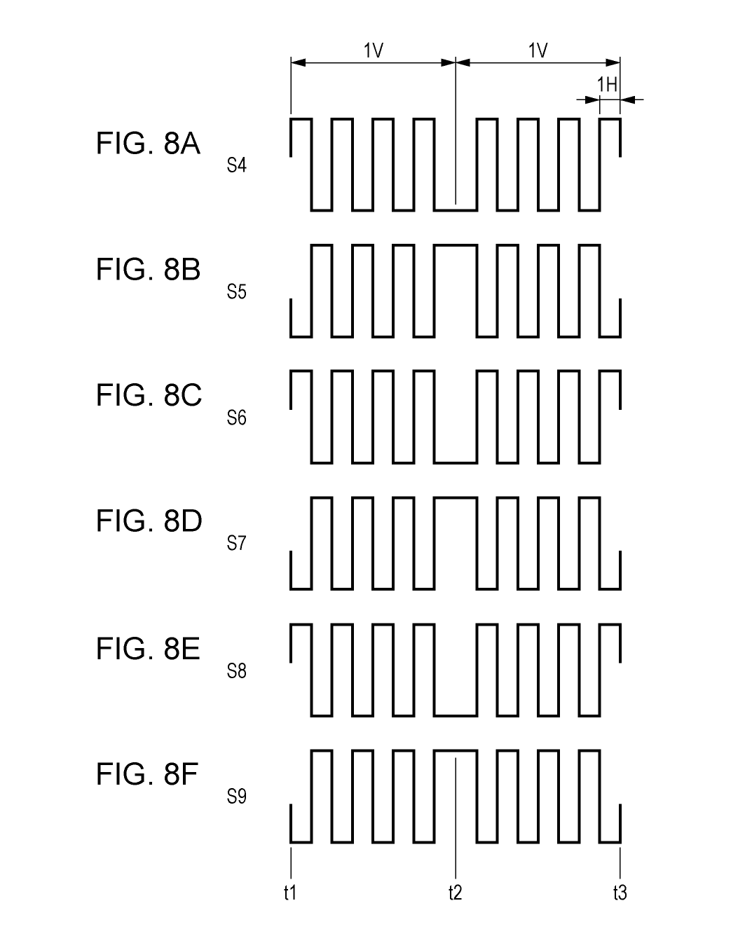

FIG. 7 is a view functionally illustrating a part of a display device according to a first comparative example. FIGS. 8A to 8F are diagrams each illustrating an output voltage waveform of a source driver during white screen display in the display device according to the first comparative example. Specifically, FIG. 8A illustrates an output voltage waveform of the source driver to the source line S4 (see FIG. 7) during white screen display. FIG. 8B illustrates an output voltage waveform of the source driver to the source line S5 (see FIG. 7) during white screen display. FIG. 8C illustrates an output voltage waveform of the source driver to the source line S6 (see FIG. 7) during white screen display. FIG. 8D illustrates an output voltage waveform of the source driver to the source line S7 (see FIG. 7) during white screen display. FIG. 8E illustrates an output voltage waveform of the source driver to the source line S8 (see FIG. 7) during white screen display. FIG. 8F illustrates an output voltage waveform of the source driver to the source line S9 (see FIG. 7) during white screen display.

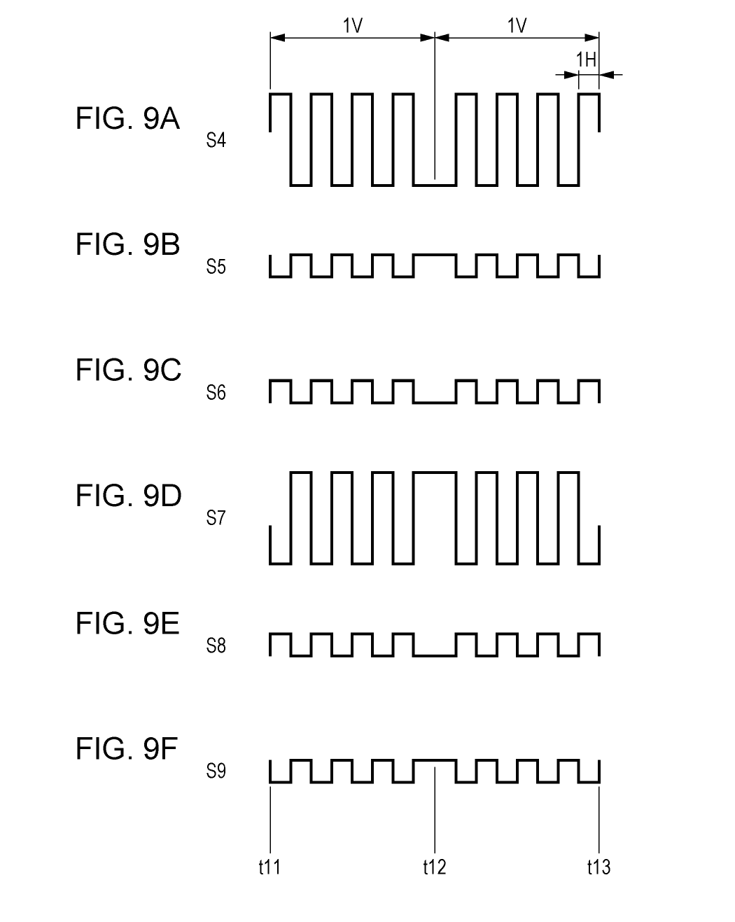

FIGS. 9A to 9F are diagrams each illustrating an output voltage waveform of the source driver during R screen display in the display device according to the first comparative example. Specifically, FIG. 9A illustrates an output voltage waveform of the source driver to the source line S4 (see FIG. 7) during R screen display. FIG. 9B illustrates an output voltage waveform of the source driver to the source line S5 (see FIG. 7) during R screen display. FIG. 9C illustrates an output voltage waveform of the source driver to the source line S6 (see FIG. 7) during R screen display. FIG. 9D illustrates an output voltage waveform of the source driver to the source line S7 (see FIG. 7) during R screen display. FIG. 9E illustrates an output voltage waveform of the source driver to the source line S8 (see FIG. 7) during R screen display. FIG. 9F illustrates an output voltage waveform of the source driver to the source line S9 (see FIG. 7) during R screen display.

In the first comparative example, dot inversion driving is performed. As illustrated in FIGS. 8A to 8F and FIGS. 9A to 9F, the output voltage waveforms of the source driver to the source lines S4 to S9 during white, black, gray, or RGB screen display change every horizontal scanning period (1H). One horizontal scanning period (1H) is shorter than one vertical scanning period (1V). As a result, power consumption and radiation noise are increased.

### Second Comparative Example

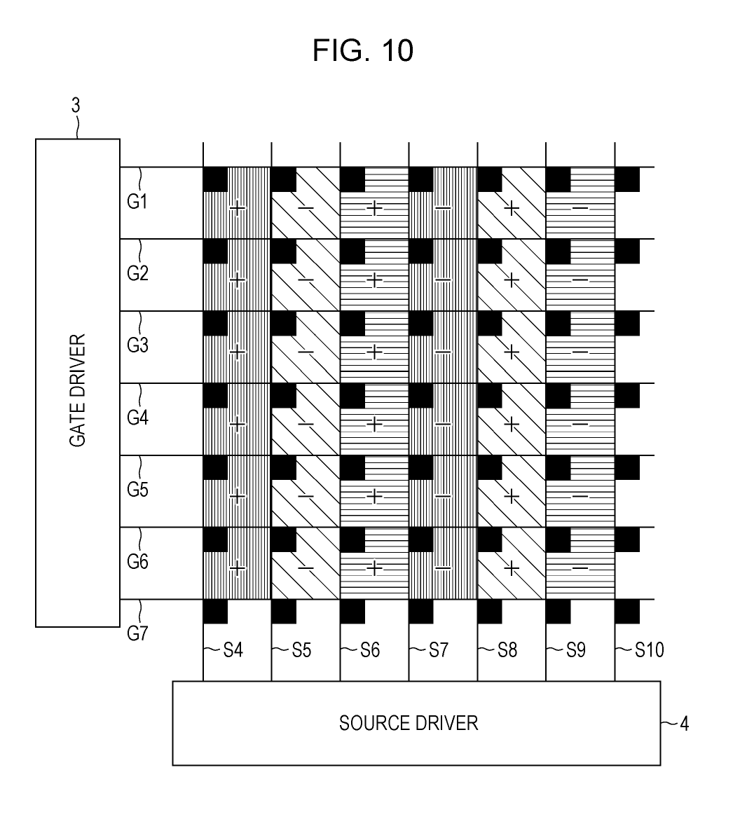

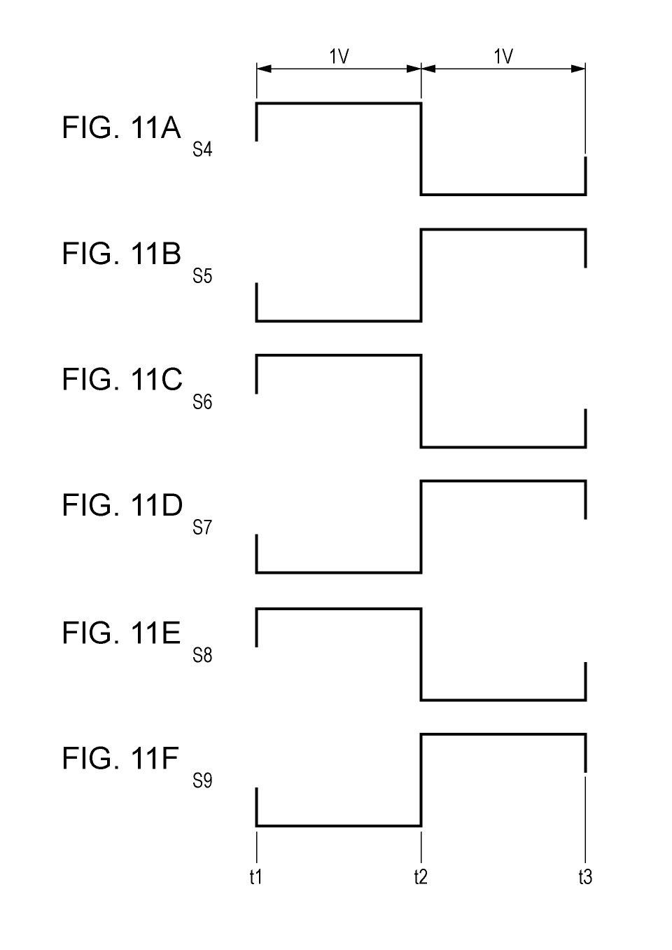

FIG. 10 is a view functionally illustrating a part of a display device according to a second comparative example. FIGS. 11A to 11F are diagrams each illustrating an output voltage waveform of a source driver during white screen display in the display device according to the second comparative example. Specifically, FIG. 11A illustrates an output voltage waveform of the source driver to the source line S4 (see FIG. 10) during white screen display. FIG. 11B illustrates an output voltage waveform of the source driver to the source line S5 (see FIG. 10) during white screen display. FIG. 11C illustrates an output voltage waveform of the source driver to the source line S6 (see FIG. 10) during white screen display. FIG. 11D illustrates an output voltage waveform of the source driver to the source line S7 (see FIG. 10) during white screen display. FIG. 11E illustrates an output voltage waveform of the source driver to the source line S8 (see FIG. 10) during white screen display. FIG. 11F illustrates an output voltage waveform of the source driver to the source line S9 (see FIG. 10) during white screen display.

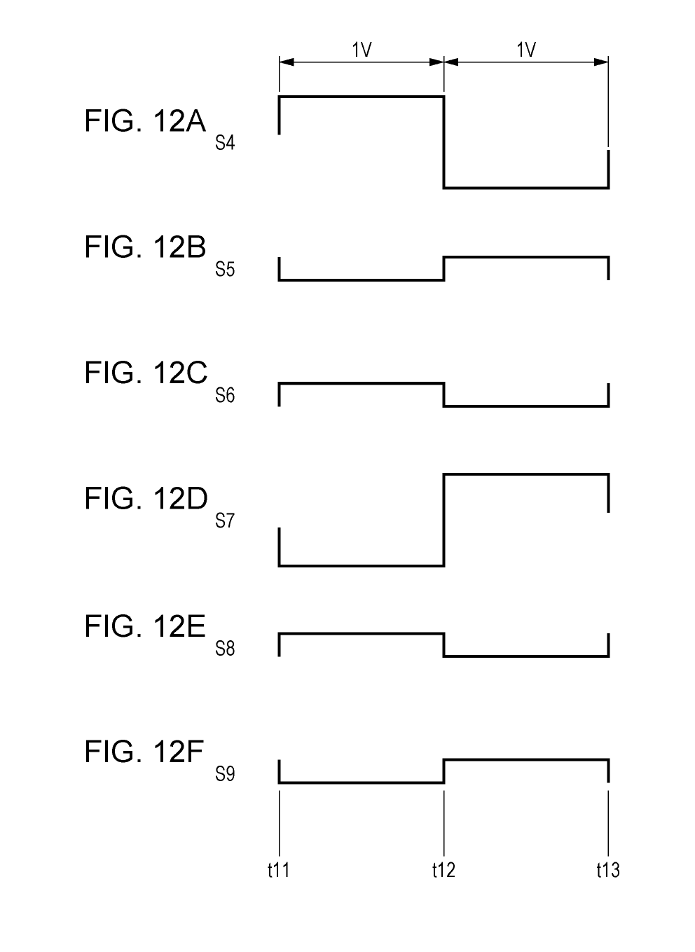

FIGS. 12A to 12F are diagrams each illustrating an output voltage waveform of the source driver during R screen display in the display device according to the second comparative example. Specifically, FIG. 12A illustrates an output voltage waveform of the source driver to the source line S4 (see FIG. 10) during R screen display. FIG. 12B illustrates an output voltage waveform of the source driver to the source line S5 (see FIG. 10) during R screen display. FIG. 12C illustrates an output voltage waveform of the source driver to the source line S6 (see FIG. 10) during R screen display. FIG. 12D illustrates an output voltage waveform of the source driver to the source line S7 (see FIG. 10) during R screen display. FIG. 12E illustrates an output voltage waveform of the source driver to the source line S8 (see FIG. 10) during R screen display. FIG. 12F illustrates an output voltage waveform of the source driver to the source line S9 (see FIG. 10) during R screen display.

In the second comparative example, source line inversion (column inversion) driving is performed. As illustrated in FIGS. 11A to 11F and FIGS. 12A to 12F, the output voltage waveforms of the source driver to the source lines S4 to S9 during white, black, gray, or RGB screen display change every vertical scanning period (1V), and power consumption can be reduced. Meanwhile, in the second comparative example, as illustrated in FIG. 10, the polarities of the picture elements are the same in the longitudinal direction. Thus, flicker in the longitudinal direction is conspicuous.

### Third Comparative Example

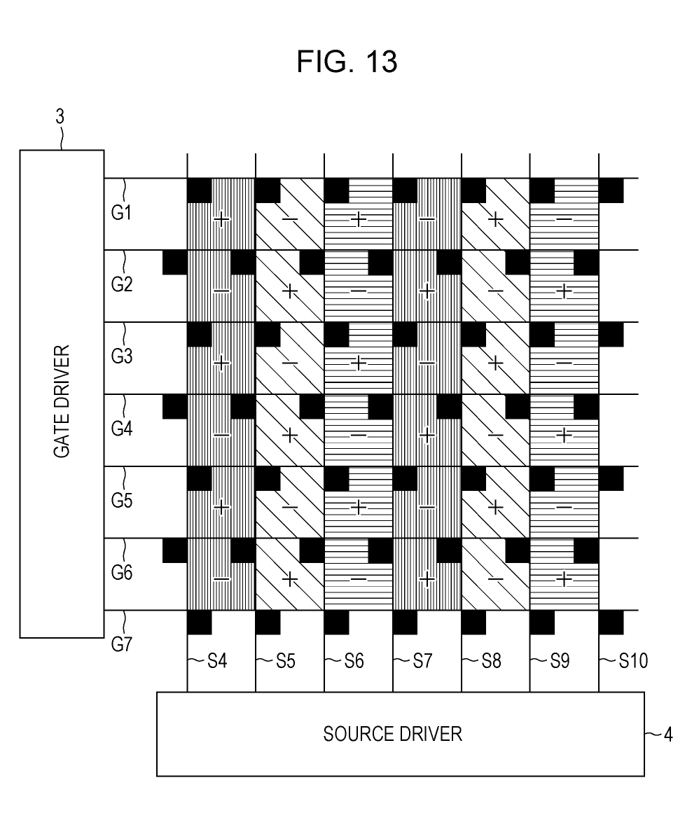

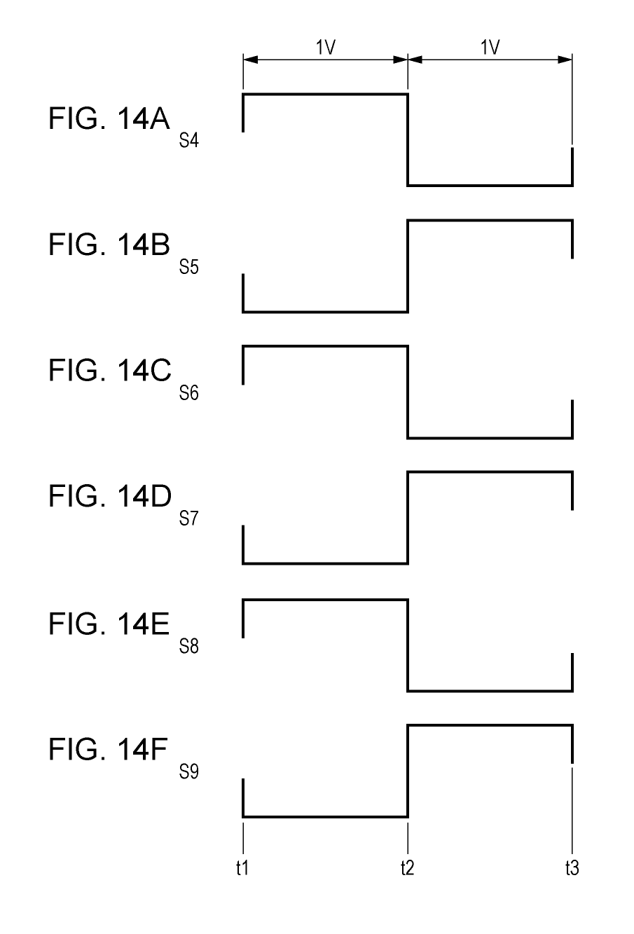

FIG. 13 is a view functionally illustrating a part of a display device according to a third comparative example. FIGS. 14A to 14F are diagrams each illustrating an output voltage waveform of a source driver during white screen display in the display device according to the third comparative example. Specifically, FIG. 14A illustrates an output voltage waveform of the source driver to the source line S4 (see FIG. 13) during white screen display. FIG. 14B illustrates an output voltage waveform of the source driver to the source line S5 (see FIG. 13) during white screen display. FIG. 14C illustrates an output voltage waveform of the source driver to the source line S6 (see FIG. 13) during white screen display. FIG. 14D illustrates an output voltage waveform of the source driver to the source line S7 (see FIG. 13) during white screen display. FIG. 14E illustrates an output voltage waveform of the source driver to the source line S8 (see FIG. 13) during white screen display. FIG. 14F illustrates an output voltage waveform of the source driver to the source line S9 (see FIG. 13) during white screen display.

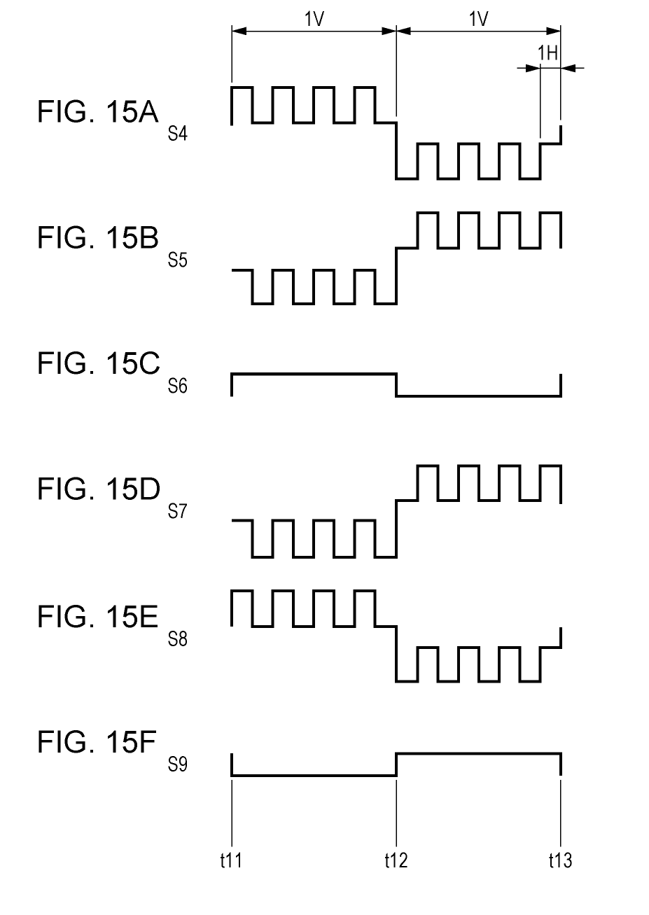

FIGS. 15A to 15F are diagrams each illustrating an output voltage waveform of the source driver during R screen display in the display device according to the third comparative example. Specifically, FIG. 15A illustrates an output voltage waveform of the source driver to the source line S4 (see FIG. 13) during R screen display. FIG. 15B illustrates an output voltage waveform of the source driver to the source line S5 (see FIG. 13) during R screen display. FIG. 15C illustrates an output voltage waveform of the source driver to the source line S6 (see FIG. 13) during R screen display. FIG. 15D illustrates an output voltage waveform of the source driver to the source line S7 (see FIG. 13) during R screen display. FIG. 15E illustrates an output voltage waveform of the source driver to the source line S8 (see FIG. 13) during R screen display. FIG. 15F illustrates an output voltage waveform of the source driver to the source line S9 (see FIG. 13) during R screen display.

In the third comparative example, Z inversion driving is performed. As illustrated in FIGS. 14A to 14F, the output voltage waveforms of the source driver to the source lines S4 to S9 during white, black, or gray screen display change every vertical scanning period (1V), and power consumption can be reduced. Meanwhile, in the third comparative example, as illustrated in FIGS. 15A to 15F, the output voltage waveforms of the source driver to the source lines S4, S5, S7, and S8 during RGB screen display change every horizontal scanning period (1H). One horizontal scanning period (1H) is shorter than one vertical scanning period (1V). As a result, power consumption and radiation noise are increased.

The exemplary embodiments according to the present disclosure have been described so far with reference to the accompanying drawings, but as a matter of course, the present disclosure is not limited to the examples. It is apparent that those skilled in the art can conceive various modifications or variations within the scope of the technical idea described in the claims, and it is understood that those modifications and variations also naturally fall within the technical scope of the present disclosure.

The present disclosure contains subject matter related to that disclosed in Japanese Priority Patent Application JP 2017-195894 filed in the Japan Patent Office on Oct. 6, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a plurality of source lines extending in a first direction; and
a plurality of gate lines extending in a second direction that intersects with the first direction, wherein
a plurality of switching elements are connected to one of the plurality of source lines,
each of the plurality of switching elements is connected to one of the plurality of gate lines,
the plurality of switching elements connected to the source line are aligned in the first direction so as to be alternately located on one side and another side of the source line, and
a plurality of picture elements that include the plurality of switching elements connected to the source line correspond to a same color.

2. The display device according to claim 1, wherein
the plurality of picture elements that include the plurality of switching elements connected to the source line take a same polarity.

3. The display device according to claim 2, wherein
the plurality of switching elements connected to the source line are aligned in the first direction so as to be alternately located on the one side and the other side of the source line one by one.

4. The display device according to claim 2, wherein
the plurality of switching elements connected to the source line are aligned in the first direction so as to be alternately located on the one side and the other side of the source line two at a time.

5. The display device according to claim 4, wherein
colors of color filters of the plurality of picture elements aligned in the first direction on one of the one side and the other side of the source line are different for each two picture elements.

6. The display device according to claim 3, wherein
an end-portion picture element on the other side of a plurality of picture elements that include a plurality of switching elements connected to a first gate line of the plurality of gate lines is arranged on the one side of an end-portion picture element on the other side of a plurality of picture elements that include a plurality of switching elements connected to a second gate line adjacent to the first gate line,
an end-portion picture element on the one side of the plurality of picture elements that include the plurality of switching elements connected to the first gate line is arranged on the one side of an end-portion picture element on the one side of the plurality of picture elements that include the plurality of switching elements connected to the second gate line,
the end-portion picture element on the other side of the plurality of picture elements that include the plurality of switching elements connected to the second gate line is arranged on the other side of an end-portion picture element on the other side of a plurality of picture elements that include a plurality of switching elements connected to a third gate line that is arranged on an opposite side of the first gate line with respect to the second gate line and is adjacent to the second gate line, and
the end-portion picture element on the one side of the plurality of picture elements that include the plurality of switching elements connected to the second gate line is arranged on the other side of an end-portion picture element on the one side of the plurality of picture elements that include the plurality of switching elements connected to the third gate line.
